(19) United States
(12) Patent Application Publication
(10) Pub. No.: US 2015/0287244 A1
(43) Pub. Date: Oct. 8, 2015

(54) EYEPIECE-TYPE DISPLAY APPARATUS AND DISPLAY CONTROL METHOD THEREFOR

(71) Applicant: CANON KABUSHIKI KAISHA, Tokyo (JP)

(72) Inventors: Kazuhiro Watanabe, Tokyo (JP); Takeshi Nakata, Kawasaki-shi (JP); Wataru Kaku, Yokohama-shi (JP)

(21) Appl. No.: 14/671,852

(22) Filed: Mar. 27, 2015

(30) Foreign Application Priority Data
Apr. 2, 2014 (JP) 2014-076403

(51) Int. Cl. G06T 19/00; G02B 27/01

(52) U.S. Cl. CPC G06T 19/006; G02B 27/0172; G02B 2027/0178

(57) ABSTRACT

An eyepiece-type display apparatus includes an imaging unit configured to capture a video of reality, a display unit configured to display a virtual image while superimposing the virtual image on the video of reality, a determination unit configured to determine whether a video being captured by the imaging unit is a video during advancing, and a display control unit configured to change a display mode of the virtual image so as not to block a user's viewing field.

### BACKGROUND OF THE INVENTION

1. Field of the Invention

The present invention relates to a technique of an eyepiece-type display apparatus for displaying graphics while superimposing the graphics on a real scenery, that is, augmented reality display.

2. Description of the Related Art

Conventionally, a technique of a head-mounted display (hereinafter referred to as HMD) has been known as one of eyepiece-type display apparatuses. The HMD is mounted on the user's head, and displays graphics on a liquid crystal display or the like at the user's eye position. A hand-held display has also been known as another known eyepiece-type display apparatus. The hand-held display is held by the user's hands so that the display faces the user's eye position. Meanwhile, there have recently appeared apparatuses for displaying graphics while superimposing the graphics on a real scenery being seen by the user, that is, augmented reality display. The types of apparatuses for superimposing graphics on a real scenery include what is called the glass see-through type and the video see-through type. The glass see-through type apparatus projects graphics by using a transparent or semi-transparent eyeglass lens as a screen. The video see-through type apparatus includes an imaging apparatus, and electrically superimposes graphics on video data of a real scenery being captured by the imaging apparatus.

Japanese Patent Application Laid-Open No. 2012-155654 discusses an information processing apparatus capable of providing a user with an augmented reality application for displaying virtual objects while superimposing the virtual objects on a real space. The information processing apparatus includes a danger recognition unit and an informing unit. When the danger recognition unit recognizes a danger to the user in the real space, the informing unit informs the user of the existence of the danger. Japanese Patent Application Laid-Open No. 2012-155654 further discusses a technique for making virtual objects transparent if a danger is recognized.

Japanese Patent Application Laid-Open No. 2010-136263 discusses a technique of an HMD having a display unit for projecting an image on the user's retina in a state where the external world is visible. The HMD projects on the user's retina a transformed image obtained by transforming a specific wavelength image, and changes an informing mode of a danger detected according to the user's moving speed. This HMD images at least a part of the viewing field of the user who wears the HMD at a specific wavelength, identifies a region having a high degree of danger in the captured specific wavelength image, and acquires the moving speed of the user who wears the HMD. Then, based on the identified region having a high degree of danger and the acquired moving speed, the HMD generates a transformed image obtained by transforming the specific wavelength image, and projects the transformed image on the user's retina.

Japanese Patent Application Laid-Open No. 2010-187132 discusses an HMD having a display unit for projecting on the user's eyes image light according to image information so as to cause the user to visually recognize an image according to the image light. This HMD includes a sleep detection unit for detecting the user's sleep based on the opening/closing state of the user's eyes. When the user's sleep is detected and then is no longer detected, the HMD performs control to display an image including an image which had been displayed since at least a predetermined time period before the time of detection of the relevant user's sleep until the time of detection of the relevant user's sleep.

In some cases, an HMD for displaying augmented reality may display texts and graphics such as diagrams and videos while superimposing them on a real scenery. Such a superimposition display has a problem that, while the user is moving on foot, the superimposition display blocks the user's viewing field in the real scenery in the advancing direction, causing a danger such as a collision or fall. On the other hand, if the display position, the display area, and the transmittance of superimpose-displayed graphics are constantly at such an extent that the viewing field in the real scenery is not blocked, the user will find it difficult to visually recognize texts, diagrams, videos, or the like, which degrades user-friendliness as a graphic display apparatus.

In other words, it is necessary to change the superimposition display of graphics in such a manner that the viewing field in the real scenery would not be blocked or may be blocked, depending on whether the user is moving himself or herself (for example, moving on foot) or not, respectively.

Japanese Patent Application Laid-Open No. 2012-155654 discusses a technique for making virtual objects transparent when a danger is recognized, but fails to discuss a technique for distinguishing between a case where the user is moving himself or herself and other cases.

Japanese Patent Application Laid-Open No. 2010-136263 discusses a technique for changing an informing mode of a danger according to the user's moving speed, but fails to discuss a technique for changing the superimposition display so as not to block the viewing field in the real scenery.

In short, in the above-described conventional techniques, it has been difficult to change the superimposition display of graphics in such a manner that the viewing field in the real scenery would not be blocked or may be blocked, depending on whether the user is moving himself or herself or not, respectively.

### SUMMARY OF THE INVENTION

The present invention is directed to an eyepiece-type display apparatus for providing high safety and high graphic visibility while a user is moving himself or herself.

According to an aspect of the present invention, an eyepiece-type display apparatus includes an imaging unit configured to capture a video of reality, a display unit configured to display a virtual image while superimposing the virtual image on the video of reality, a determination unit configured to determine whether a video being captured by the imaging unit is a video during advancing, and a display control unit configured to, in a case where the determination unit determines that the video being captured by the imaging unit is a video during advancing, change a display mode of the virtual image so as not to block a user's viewing field.

Further features of the present invention will become apparent from the following description of exemplary embodiments with reference to the attached drawings.

### BRIEF DESCRIPTION OF THE DRAWINGS

FIG. 1 illustrates an example of an outer appearance of an HMD as an example of a display apparatus according to an exemplary embodiment.

FIG. 2 is a block diagram illustrating a configuration example of the HMD according to an exemplary embodiment.

FIGS. 3A, 3B, 3C and 3D are flowcharts illustrating determination and processing performed by an HMD according to a first exemplary embodiment.

FIGS. 4A and 4B illustrates an example of a display transition in which display positions of graphic elements are changed.

FIG. 5 illustrates an example of an advancing navigation image.

FIG. 6 is a flowchart illustrating determination and processing performed by the HMD according to the first exemplary embodiment.

FIG. 7 illustrates an example of display in which an advancing navigation image is superimposed on display of an image captured with infrared light.

FIG. 8 is a flowchart illustrating determination and processing performed by the HMD according to the first exemplary embodiment.

FIG. 9 is a flowchart illustrating determination and processing performed by an HMD according to a second exemplary embodiment.

FIG. 10 illustrates an outer appearance of an HMD as an example of a display apparatus according to a third exemplary embodiment.

FIG. 11 is a block diagram illustrating a configuration example of the HMD according to the third exemplary embodiment.

FIG. 12 is a flowchart illustrating determination and processing performed by the HMD according to the third exemplary embodiment.

### DESCRIPTION OF THE EMBODIMENTS

An eyepiece-type display apparatus and a display control method therefor according to an exemplary embodiment of the present invention will be described in detail below with reference to the accompanying drawings.

In a first exemplary embodiment described below, the present invention is applied to what is called a glass see-through type HMD as an example of an eyepiece-type display apparatus.

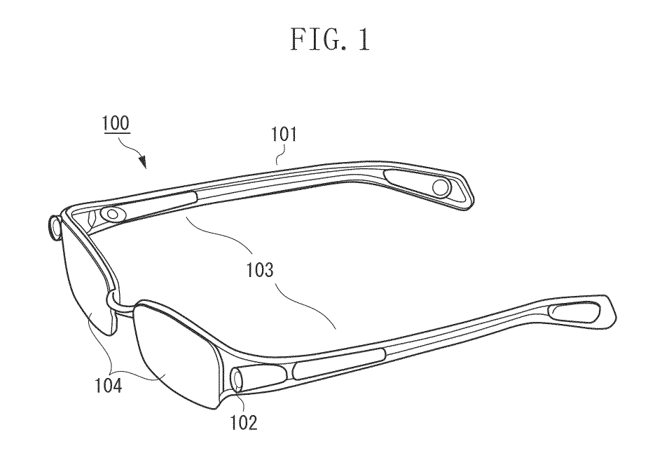

FIG. 1 illustrates an outer appearance of an HMD 100 according to the present exemplary embodiment.

The HMD 100 includes a head mounting unit 101 for mounting the HMD 100 on the user's head, an imaging unit 102 for capturing a video of a real scenery in the forward direction of the user's head, a projection unit 103 for projecting graphics, and an eyepiece unit 104 on which graphics are projected.

The head mounting unit 101 has a similar structure to what is called an eyeglass frame. The head mounting unit 101 is supported on the user's ears and nose so that the HMD 100 according to the present exemplary embodiment is mounted on the user's head. In addition to the eyeglass frame type illustrated in FIG. 1, diverse types of the head mounting unit 101, such as a goggle type and a helmet type, can be used. An elastic material may be used to improve the mountability.

The imaging unit 102 has a similar configuration to what is called a digital camera. The imaging unit 102 includes an imaging lens, a diaphragm, an imaging sensor for converting an optical image into an electrical signal, and an analog-to-digital (A/D) converter for converting an analog signal into a digital signal. The imaging unit 102 captures an image in substantially the same direction as the direction in which the face of the user wearing on the head the HMD 100 according to the present exemplary embodiment is oriented (a direction equivalent to the user's viewing field). The imaging unit 102 further includes various types of optical filters for the purpose of improving the image quality or the like. In particular, an infrared cut filter is generally provided on the light incidence side of the imaging sensor since near-infrared light is likely to be harmful light when capturing a color video. There may also be provided a mechanism for evacuating the infrared cut filter out of the light path so that more light enters the imaging sensor when the visible light amount is low (for example, an imaging unit discussed in Japanese Patent Application Laid-Open No. 2008-35199).

The projection unit 103, what is called a projector, includes a projection lens, and small image display elements and light emitting elements, such as liquid crystal elements and organic electro luminescence (EL) elements. The projection unit 103 projects on the eyepiece unit 104 image light of graphics to be displayed.

The eyepiece unit 104 is provided at a position equivalent to the eyeglass lens position so that the unit faces the user's eye position. The eyepiece unit 104 includes mirrors embedded in its front face, rear face, or inside. Each mirror is what is called a half mirror having a certain level of transmittance so as to allow the user to see an external real scenery. The half mirror also has a certain level of reflectance so as to reflect toward the user's eyes the image light projected from the projection unit 103. In other words, in the HMD 100 according to the present exemplary embodiment, the projection unit 103 and the eyepiece unit 104 constitute a display unit through which the user can see an image of the external real scenery with graphics superimposed thereon.

Each of the above-described half mirrors of the eyepiece unit 104 may have a liquid crystal layer on the surface of a transmitting member or a reflecting member so that the transmittance or reflectance can be electrically changed by changing the orientation of the liquid crystal layer. Alternatively, the eyepiece unit 104 may be formed of a liquid crystal display, and graphics may be displayed on the eyepiece unit 104 while electrically superimposing the graphics on video data of the real scenery captured by the imaging unit 102. In this case, the projection unit 103 can be omitted.

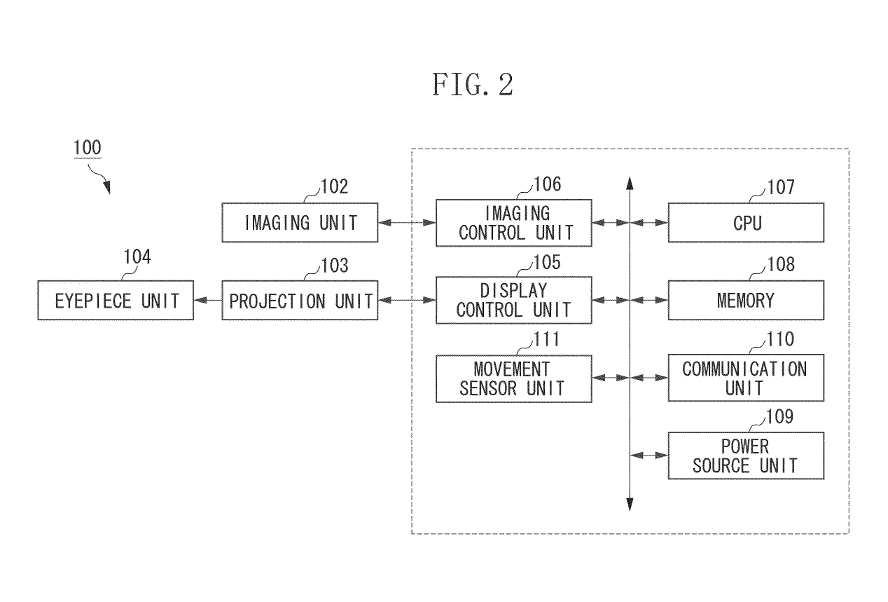

FIG. 2 is a block diagram illustrating a configuration example of the HMD 100 according to the present exemplary embodiment.

The HMD 100 further includes some units which are embedded in the inside of the main unit including the head mounting unit 101, and are not illustrated in FIG. 1 as an outer appearance. These embedded units include a display control unit 105, an imaging control unit 106, a central processing unit (CPU) 107, a memory 108, a power source unit 109, a communication unit 110, and a movement sensor unit 111.

The display control unit 105 controls the above-described projection unit 103 and eyepiece unit 104 to perform display control of the display unit. For example, the display control unit 105 performs image processing, such as coordinate movement and resizing, on graphic data projected from the projection unit 103 to change the display position and display area of a virtual image. Alternatively, the display control unit 105 controls the light emission amount of the light emitting elements of the projection unit 103 and the transmittance and reflectance of the eyepiece unit 104 to change the transmittance of the virtual image. In the case of what is called the video see-through type in which graphics are electrically superimposed on video data of the real scenery captured by the imaging unit 102, the display position, the display area, and the transmittance of the virtual image may be changed through image processing at the time of graphics superimposition.

The imaging control unit 106 performs exposure control and ranging control based on the calculation result of predetermined calculation processing by using imaging data. Thus, automatic focus (AF) processing, automatic exposure (AE) processing, and automatic white balance (AWB) processing are performed. When the imaging unit 102 includes a mechanism for inserting and removing optical filters into/from the light path or an image stabilization mechanism, the imaging control unit 106 performs control for filter insertion/removal and image stabilization based on the imaging data and other conditions.

The CPU 107 controls the entire HMD 100 and executes calculation processing. Each process according to the present exemplary embodiment is implemented by the CPU 107 executing a program recorded in the memory 108 to be described below. The memory 108 includes a system memory and a nonvolatile memory. A program read from the nonvolatile memory, and constants and variables for system control are loaded into the system memory. The memory 108 stores data of a virtual image to be displayed while being superimposed on a real scenery, for the purpose of display. The memory 108 further stores data captured and subjected to A/D-conversion by the imaging unit 102, for the purpose of image analysis and image processing.

The power source unit 109 includes a primary battery such as an alkaline battery and a lithium battery, and a secondary battery such as a nickel-cadmium (NiCd) battery, a nickel-metal hydride (NiMH) battery, and a lithium-ion (Li) battery, and an alternating current (AC) adaptor to supply power to the entire HMD 100. The power source unit 109 further includes a power switch for turning power ON and OFF according to a user's operation and other conditions.

Under the control of the CPU 107, the communication unit 110 performs communication with an information terminal such as a personal computer (PC), and with a network such as a local area network (LAN) and the Internet. The movement sensor unit 111 detects a moving state of the HMD 100 by, for example, detecting the gravitational acceleration. Alternatively, the communication unit 110 may be provided with a global positioning system (GPS) receiving unit, and the movement sensor unit 111 may detect a moving state based on a GPS signal received by the GPS receiving unit. Detecting a moving distance in a unit time according to the moving state detected in this way enables calculation of the moving speed per the relevant unit time.

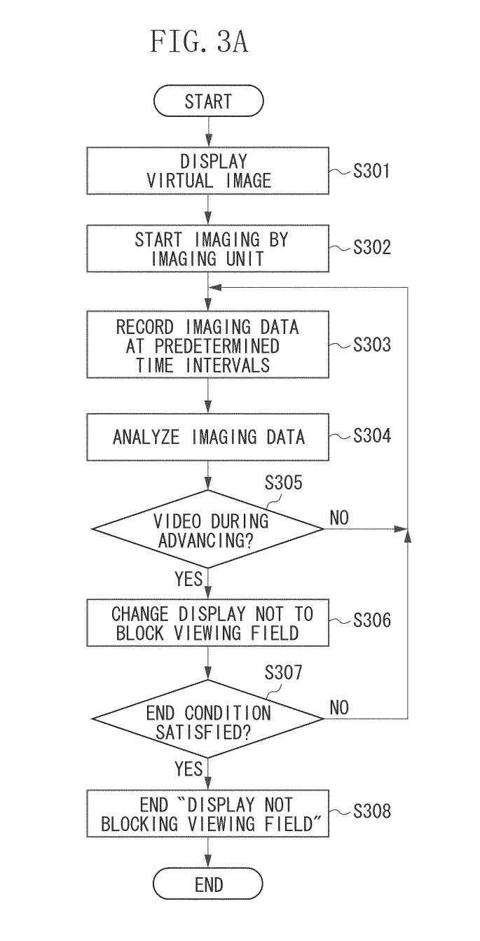

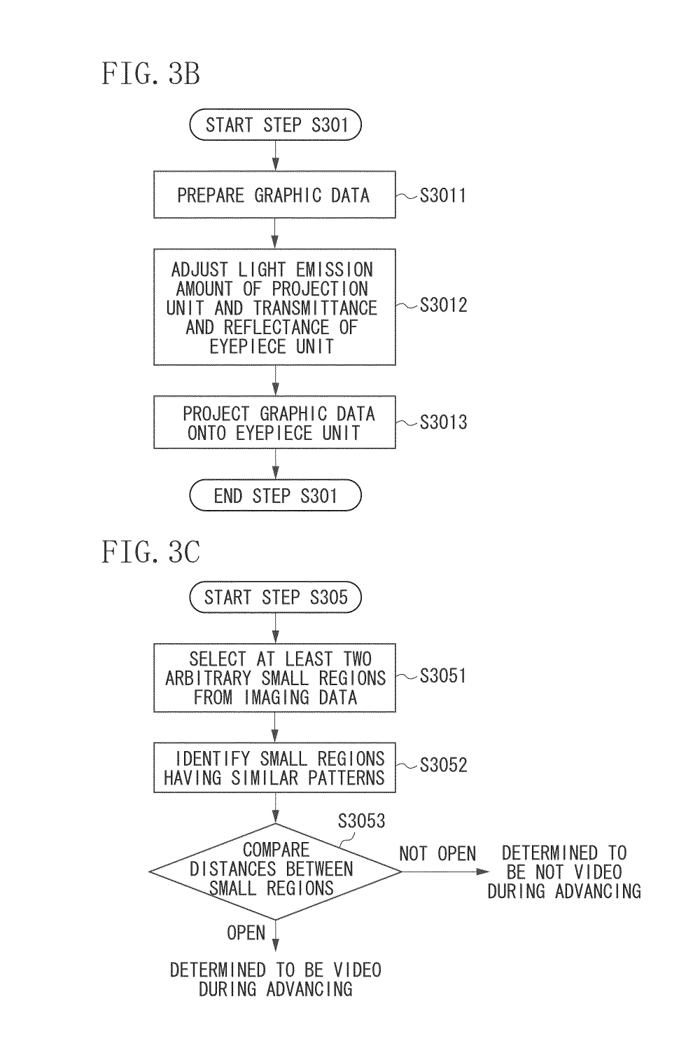

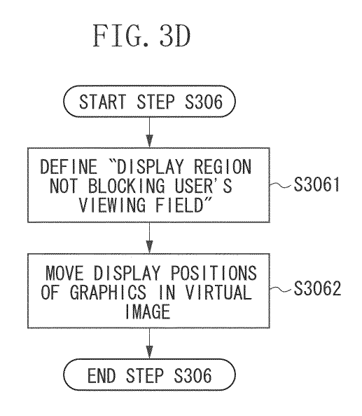

FIGS. 3A, 3B, 3C and 3D are flowcharts illustrating determination and processing performed by the HMD according to the present exemplary embodiment. The determination and processing are implemented by the CPU 107 loading a program recorded in the nonvolatile memory of the memory 108 into the system memory, and then executing the program.

When the user turns power ON, in step S301, the HMD 100 according to the present exemplary embodiment displays a virtual image in a predetermined display mode (display position, display area, and transmittance). The details of the processing in step S301 will be described with reference to FIG. 3B. In step S3011, the display control unit 105 prepares graphic data. In step S3012, the display control unit 105 adjusts the light emission amount of the light emitting elements of the projection unit 103 and the transmittance and reflectance of the eyepiece unit 104. In step S3013, the projection unit 103 projects onto the eyepiece unit 104 an image according to the graphic data generated in this way. Graphics to be displayed immediately after power is turned ON may be graphics of what is called a main user interface (UI). The main UI displays, for example, a list of icons indicating functions of the apparatus, depending on apparatus specifications. In addition, after the above operation, information about graphics which had been displayed immediately before power disconnection may be stored, and then, based on the stored information, the graphics having been displayed before power disconnection may be recovered to be used.

Referring back to FIG. 3A, in step S302, the CPU 107 of the HMD 100 starts imaging by the imaging unit 102. In step S303, the CPU 107 then records relevant imaging data in the memory 108 at predetermined time intervals. In step S304, the CPU 107 analyzes the imaging data recorded in the memory 108. In step S305, the CPU 107 then determines whether the relevant video is a video captured while the user is advancing in the imaging direction of the imaging unit 102.

The CPU 107 makes the determination by comparing two different pieces of imaging data captured at the predetermined time interval. The details of the processing in step S305 will be described with reference to FIG. 3C. In step S3051, the CPU 107 selects at least two arbitrary small regions from imaging data captured earlier. In step S3052, the CPU 107 then identifies from imaging data captured later small regions respectively having similar patterns to the small regions selected from the imaging data captured earlier. In step S3053, the CPU 107 compares the distance between the small regions in the imaging data captured earlier with the distance between the small regions in the imaging data captured later. When the distance between the small regions in the imaging data captured later is longer than the distance between the small regions in the imaging data captured earlier as a result of the comparison (OPEN in step S3053), the CPU 107 determines that the user is currently advancing in the imaging direction of the imaging unit 102 (i.e., approaching an imaging target). The imaging unit 102 is capturing a scenery in the direction in which the user's face is oriented. Therefore, if the user is advancing in the forward direction with his or her face oriented forward, an object image in the imaging data captured by the imaging unit 102 would be enlarged as the user advances. For this reason, when the distance between the small regions in the imaging data captured later is longer than the distance between the small regions in the imaging data captured earlier, the CPU 107 can determine that the user is advancing in the imaging direction of the imaging unit 102 (in the forward direction of the user).

If the small regions in the above-described imaging data include a video of the object within a close range, the enlargement ratio according to the user's advance increases, which is advantageous to detection of advancing. Therefore, distance information of the object may be utilized to select small regions. The distance information of the object can be generated, for example, according to the parallax of the object in imaging data captured by using a plurality of imaging units 102. In addition, to improve the accuracy of the determination, for example, imaging data comparison may be successively performed at certain time intervals. More specifically, the CPU 107 sequentially performs comparison of the distances between small regions between imaging data captured at predetermined time intervals. When a state where the distance between the small regions in the imaging data captured later is more open than the distance between the small regions in the imaging data captured earlier continues for a certain time period (for example, an integral multiple of the predetermined time interval), the CPU 107 determines that the user is highly likely to be advancing in the imaging direction of the imaging unit 102.

When the CPU 107 determines that the relevant video is a video during advancing (YES in step S305), then in step S306, the display control unit 105 changes any of the display position, the display area, and the transmittance of the virtual image display so as not to block the user's viewing field.

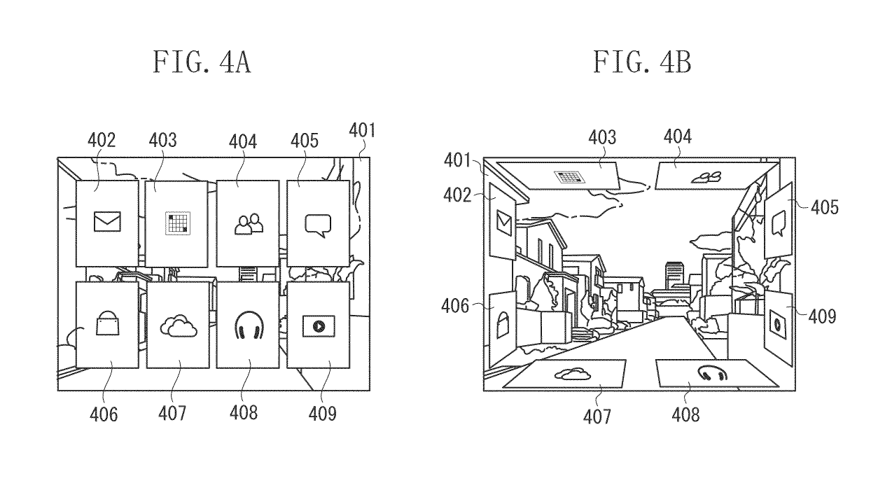

In order to change the display position not to block the user's viewing field, for example, in step S3061 in FIG. 3D, the display control unit 105 initially predefines a “display region not blocking the user's viewing field.” For example, when a region in which the superimposition display of the virtual image is possible has a size of 1600 pixels (horizontal) by 1200 pixels (vertical), a region ranging from the peripheral edge portion of the relevant region to 200 pixels is defined as a “display region not blocking the user's viewing field.” In step S3062, the display control unit 105 then moves the display positions of the graphics in the virtual image having been displayed over the entire displayable region so that the graphics are displayed only in the “display region not blocking the user's viewing field.” For example, the display control unit 105 changes the display positions of graphic elements 402 to 409 having been displayed in the display screen as illustrated in FIG. 4A so that the graphic elements 402 to 409 fit into a certain range from the peripheral edge portion of the display screen, i.e., the “display region not blocking the user's viewing field”, as illustrated in FIG. 4B. For example, if two different display modes of “display which may block the viewing field” and “display which does not block the viewing field” are predefined for each arrangement pattern of graphic elements such as icons, the display positions of such graphic elements can be moved.

The display area can be changed so as not to block the user's viewing field by performing image processing of resizing (reduction) on each graphic element. In this case, for example, all of graphic elements may be resized at a similar ratio, or resizing may be performed in such a manner that graphics displayed in the central portion of the display region is resized at a large ratio while graphics displayed in the peripheral edge portion is resized at a small ratio.

In order not to block the user's viewing field, the transmittance of graphics to be displayed may be changed. In this case, the light emission amount of the light emitting elements of the projection unit 103 is changed. Alternatively, when the eyepiece unit 104 having variable transmittance and reflectance is used, the transmittance of graphic display can also be changed by changing the transmittance and reflectance of the eyepiece unit 104. In this case, for example, a similar transmittance may be set to all of the graphic elements, or transmittances may be set in such a manner that a high transmittance is set to graphics displayed in the central portion of the display region while a low transmittance is set to graphics displayed in the peripheral edge portion. The above-described display position, display area, and transmittance of the virtual image may be changed individually or in combination.

Referring back to FIG. 3A, in step S307, the HMD 100 according to the present exemplary embodiment determines whether a predetermined end condition is satisfied. When the end condition is determined to be satisfied (YES in step S307), then in step S308, the HMD 100 ends the mode of “display which does not block the viewing field”, i.e., changes the display so as to return to the mode of “display which may block the viewing field.”

FIGS. 4A and 4B illustrate an example of a display transition in which the display positions of graphic elements are changed. FIG. 4A illustrates an example of display positions of graphic elements in what is called the mode of “display which may block the viewing field” before the imaging data is determined to be a video during advancing. Referring to FIG. 4A, an image (a scenic image) 401 of the real space is visible to the user through the eyepiece unit 104. The graphic elements 402 to 409 are projected on the eyepiece unit 104 by the projection unit 103 to be displayed thereon while being superimposed on the image 401.

FIG. 4B illustrates an example of display positions of graphic elements in what is called the mode of “display which does not block the viewing field” after the imaging data is determined to be a video during advancing. Referring to FIG. 4B, the graphic elements 402 to 409 are displayed only in a certain range from the peripheral edge portion (the “display region not blocking the user's viewing field”) so as not to block the user's viewing field from the central portion.

As described above, the HMD 100 according to the present exemplary embodiment changes the display positions and/or the like of graphics depending on the result of determination of whether the imaging data captured by the imaging unit 102 is a video during advancing. Accordingly, the HMD 100 is able to control the virtual image display according to the user's advancing state, thereby improving safety and graphic visibility.

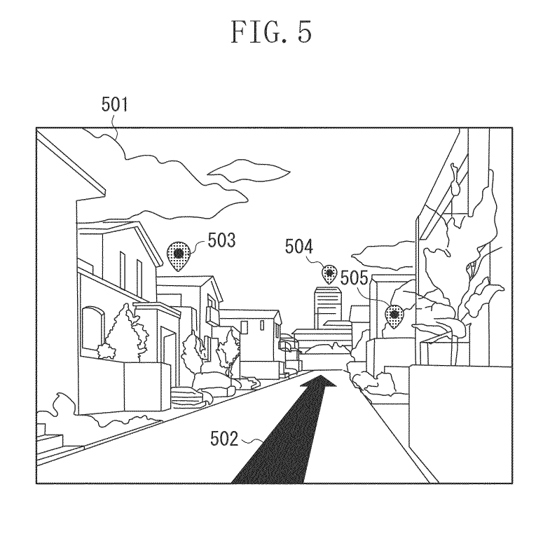

FIG. 5 illustrates an example of an advancing navigation image displayed on the HMD 100 according to the present exemplary embodiment.

The “advancing navigation image” refers to an image displayed according to advancing navigation information for guiding (navigating) the user to a target position. The advancing navigation image includes a course along which the user should advance to the target position, and descriptions and symbols of buildings, installations, and traffic signs that can be used as a landmark. The advancing navigation image includes an image of a course display 502 indicating a course, and images of description displays 503, 504, and 505 of buildings and the like.

For example, the CPU 107 acquires the user's current position based on the above-described GPS signal, and detects a region equivalent to the user's viewing field by using an acceleration sensor or the like included in the movement sensor unit 111. Further, based on such information as the course display 502 indicating the course, the description displays 503, 504, and 505 of buildings and the like, which have separately defined positions in the real space, the CPU 107 determines positions where images corresponding to these displays are to be displayed on the eyepiece unit 104. The display positions may be determined by the CPU 107 by analyzing the imaging data captured by the imaging unit 102. After determination of display positions, the CPU 107 causes, via the display control unit 105, the projection unit 103 to project these images on the eyepiece unit 104. As a result, the user can see a scenic image 501 through the eyepiece unit 104, and see the image of the course display 502 indicating the course, and the images of the description displays 503, 504, and 505 of buildings and the like superimposed on the scenic image 501.

This “advancing navigation image” displays a course along which the user should advance for the purpose of helping the user to advance. Therefore, even if the advancing navigation image blocks the user's viewing field in the real scenery in the advancing direction to a certain extent, the image does not disturb the user's advance. Changing the display positions of graphic elements in the “advancing navigation image” while the user is moving himself or herself (while the user is advancing in the imaging direction of the imaging unit 102) may defeat the purpose of displaying the “advancing navigation image.”

In view of the foregoing, when the image of the virtual information to be superimposed on the user's viewing field is an “advancing navigation image”, the HMD 100 according to the present exemplary embodiment does not change display positions in the relevant virtual image in such a manner that the user's viewing field is not blocked.

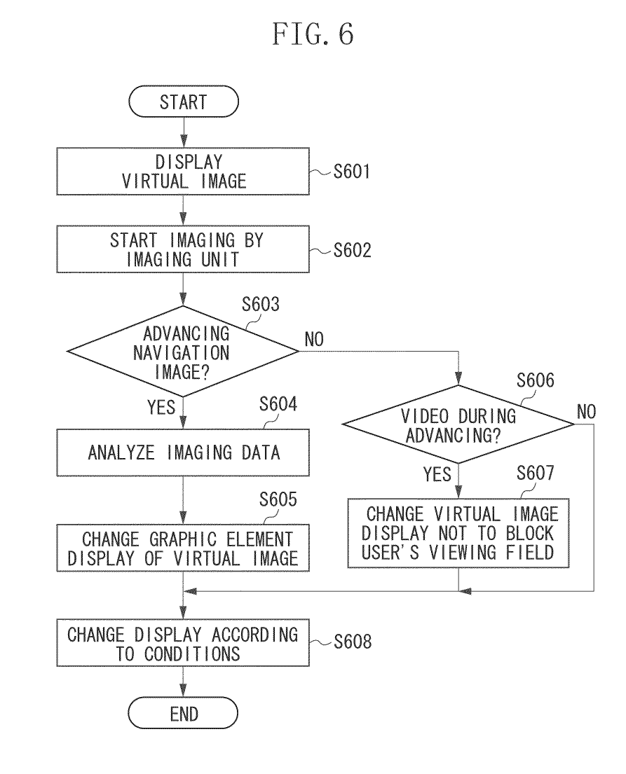

FIG. 6 is a flowchart illustrating determination and processing performed by the HMD 100 according to the present exemplary embodiment in a case where such display control is performed.

When the user turns power ON, in step S601, the HMD 100 according to the present exemplary embodiment displays a virtual image according to predetermined display conditions (display position, display area, and transmittance). In step S602, the CPU 107 of the HMD 100 starts imaging by the imaging unit 102.

In step S603, the CPU 107 then determines whether the relevant virtual image currently displayed is an “advancing navigation image.” The kind of a virtual image to be displayed immediately after power-ON is determined based on apparatus specifications as described above. When apparatus specifications are such that, for example, a virtual image having been displayed when power is turned OFF is to be recovered and displayed immediately after power-ON, the CPU 107 determines whether an “advancing navigation image” had been displayed when power was turned OFF.

When the CPU 107 determines that the virtual image is an “advancing navigation image” (YES in step S603), then in step S604, the CPU 107 analyzes the imaging data. In step S605, the CPU 107 changes display of graphic elements in the virtual image based on the imaging data. For example, when the current position and orientation of the HMD 100 differ from the position and orientation at the time of power disconnection, the CPU 107 changes, in accordance with these changes, the display positions of graphics such as the course display 502 and the description displays 503, 504, and 505 of buildings and the like.

However, the CPU 107 does not change the display mode in such a manner that the user's viewing field is not blocked. More specifically, the CPU 107 neither moves graphics from the center to the peripheral edge portion of the display unit nor changes the display area and the transmittance of graphics.

On the other hand, when the CPU 107 determines that the virtual image is not an “advancing navigation image” (NO in step S603), then in step S606, the display control unit 105 determines whether the virtual image is a video during advancing, through imaging data analysis. When the CPU 107 determines that the virtual image is a video during advancing (YES in step S606), then in step S607, the CPU 107 changes the display mode of the virtual image so as not to block the user's viewing field, as described above.

In step S608, the CPU 107 then changes display according to conditions, such as user's instruction operations and e-mail reception. For example, when the user specifies a music playback function, the CPU 107 displays a graphical user interface (GUI) for track selection and sound volume specification.

When the virtual image to be displayed is an advancing navigation image, the HMD 100 according to the present exemplary embodiment does not change the display mode (display position, display area, and transmittance) of the virtual image. Thus, the advancing navigation image can be reliably displayed without disturbing the user's advance.

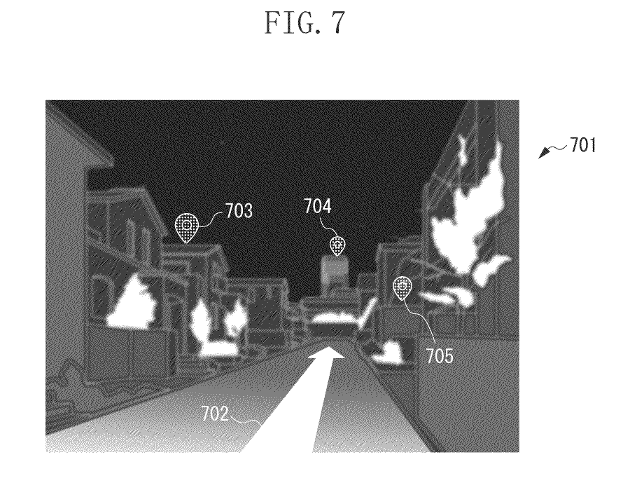

FIG. 7 illustrates an example of display on the HMD 100 according to the present exemplary embodiment in which the above-described advancing navigation image is superimposed on the image captured with infrared light (infrared light video).

In the infrared light video, when the surface temperatures of real objects (objects to be measured), such as buildings, installations, plants, and animals, differ from the air temperature, these objects can be displayed in a distinguishable manner even in the state of night vision.

An imaging unit such as a digital camera generally includes an infrared cut filter on the light incidence side of an imaging sensor for the purpose of improving the color image quality. The imaging unit 102 of the HMD 100 according to the present exemplary embodiment includes an infrared cut filter which can be evacuated out of the light path. When capturing an infrared light video, the infrared cut filter is evacuated out of the light path.

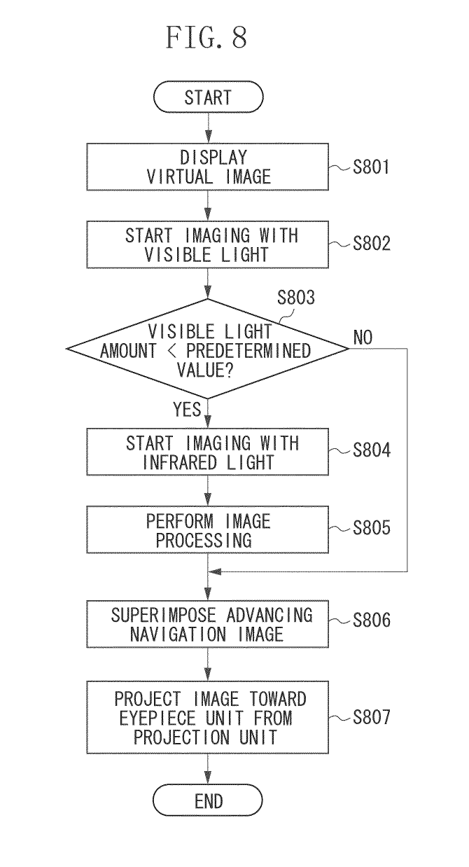

FIG. 8 is a flowchart illustrating determination and processing performed by the HMD 100 according to the present exemplary embodiment in a case where such display control is performed.

When the user turns power ON, in step S801, the HMD 100 according to the present exemplary embodiment displays a virtual image in a predetermined display mode (display position, display area, and transmittance). In step S802, the imaging unit 102 starts capturing a visible light video.

In step S803, the CPU 107 then determines whether the light amount of the visible light video (visible light amount) is less than a predetermined value. This process of visible light amount determination is executed in a similar way to the condition determination for automatic exposure (AE) or automatic flash light emission control performed by an ordinary digital camera.

When the visible light amount is less than the predetermined value (YES in step S803), then in step S804, the imaging unit 102 starts capturing an infrared light video by evacuating the infrared cut filter out of the light path. Then, in step S805, the display control unit 105 appropriately performs image processing, such as contour enhancement and color conversion, on the infrared light video from the imaging unit 102. In step S806, the display control unit 105 superimposes the “advancing navigation image” from the CPU 107 on the infrared light video. In step S807, the projection unit 103 projects the resultant video toward the eyepiece unit 104. The luminance and other display conditions of the advancing navigation image may be changed depending on the luminance and other conditions of the infrared light video. In this case, since the virtual image is an above-described advancing navigation image, the CPU 107 does not change the virtual image display according to whether the movement satisfies a predetermined condition.

Through such display control, as illustrated in FIG. 7, for example, an image of an infrared light video 701 is projected on the eyepiece unit 104 with an image of a course display 702 indicating a course and images of description displays 703, 704, and 705 of buildings and the like being superimposed on the infrared light video 701.

With the HMD 100 according to the present exemplary embodiment, when the light amount of the visible light video captured by the imaging unit 102 is less than the predetermined value, the image of the infrared light video with the advancing navigation image superimposed thereon can be projected on the eyepiece unit 104. As a result, the advancing navigation image can be reliably displayed even in the case of night vision.

An HMD 100 according to a second exemplary embodiment has a similar configuration to the HMD 100 according to the first exemplary embodiment as illustrated in FIGS. 1 and 2.

With the HMD 100 according to the present exemplary embodiment, when a video captured by the imaging unit 102 satisfies a predetermined condition for determining that the relevant video is a video during advancing, and the movement sensor unit 111 detects a movement satisfying a predetermined condition, the CPU 107 changes the virtual image display so as not to block the user's viewing field.

The movement sensor unit 111 includes a sensor, such as an acceleration sensor and a position sensor, capable of detecting a movement of the user per unit time. Various types of acceleration sensors are practicably provided. Examples of acceleration sensors include a sensor having a movable magnet or a movable magnetic member for detecting the magnetic change due to acceleration, a sensor for detecting the potential change due to the piezoelectric effect, and a sensor for detecting, as the electrostatic capacitance change, the slight positional change of a minute movable part supported by a beam structure. A position sensor detects the current position. As an example of a common position sensor, a global positioning system (GPS) receives beacons from at least three satellites having calibrated time, and performs position detection based on distance-based delays of these beacons.

With the HMD 100 according to the present exemplary embodiment, when the captured video is determined to be a video during advancing and the movement sensor unit 111 detects a movement satisfying a predetermined condition, the CPU 107 changes the virtual image display so as not to block the user's viewing field. In other words, with the HMD 100 according to the present exemplary embodiment, when the movement sensor unit 111 does not detect a movement satisfying a predetermined condition, the CPU 107 does not change the virtual image display to maintain the current virtual image even if the captured video is determined to be a video during advancing.

Even if the captured video is determined to be a video during advancing, it cannot always be determined that the user is moving himself or herself. This applies to, for example, a case where the user sees an “advancing video” projected on an external display screen via the eyepiece unit 104 of the HMD 100 according to the present exemplary embodiment. Accordingly, the likelihood of the determination can be improved by adding the fact that the movement sensor unit 111 detects a movement satisfying a predetermined condition as a condition for determining that the user is moving himself or herself. If, however, it is determined that the user is moving himself or herself simply based on the fact that the movement sensor unit 111 detects the user's movement, the CPU 107 may determine that the user is moving himself or herself even in such a case where the user is moving by vehicle such as a train. This will remarkably reduce the likelihood of the determination, so such a determination method is not appropriate. For this reason, the CPU 107 will determine that the user is moving himself or herself only when a movement satisfying a predetermined condition is detected.

A movement satisfying a predetermined condition refers to, for example, a movement at a predetermined speed or higher. The moving speed can be calculated by integrating the acceleration detected by the acceleration sensor of the movement sensor unit 111 over a predetermined time period, or by detecting the positional change in a unit time by using a position sensor. Since the moving speed of a vehicle is generally considered to be higher than a walking speed of a human, it is possible to distinguish between a case where the user is moving himself or herself and a case where the user is moving by vehicle, based on the moving speed.

Alternatively, a movement satisfying a predetermined condition refers to a movement with a predetermined moving locus pattern. Generally, the moving locus linearity in a section having a predetermined length (for example, about 1 to 3 meters) in movement by vehicle is considered to be higher than that in movement by human walk. Therefore, for example, by comparing the relevant linearities, it is possible to distinguish between a case where the user is moving himself or herself and a case where the user is moving by vehicle.

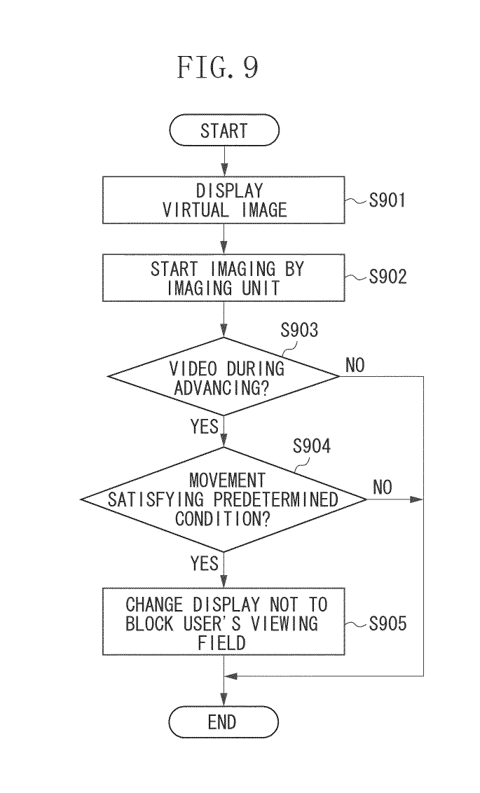

FIG. 9 is a flowchart illustrating determination and processing performed by the HMD 100 according to the present exemplary embodiment in a case where such display control is performed.

When the user turns power ON, in step S901, the HMD 100 displays a virtual image in a predetermined display mode (display position, display area, and transmittance). In step S902, the HMD 100 then starts imaging by the imaging unit 102. In step S903, the HMD 100 analyzes the relevant imaging data to determine whether the virtual image is a video during advancing. When the HMD 100 determines that the virtual image is a video during advancing (YES in step S903), then in step S904, the HMD 100 further determines whether the movement sensor unit 111 detects a movement satisfying a predetermined condition. When the HMD 100 determines that a movement satisfying a predetermined condition is detected (YES in step S904), then in step S905, the HMD 100 changes any of the display position, the display area, and the transmittance of the image of the virtual information so as not to block the user's viewing field.

With the HMD 100 according to the present exemplary embodiment, when the captured video is determined to be a video during advancing, the CPU 107 changes the virtual image display so as not to block the user's viewing field only when the movement sensor unit 111 detects a movement satisfying a predetermined condition. As a result, a state where the user is moving himself or herself can be accurately determined, and the virtual image display can be changed according to the user's movement.

An HMD according to a third exemplary embodiment includes a wearer imaging unit 1011 (an example of an eye-closing detection unit) for detecting the open/close state of the user's eyes. When the wearer imaging unit 1011 detects that the user's eyes have been closed for a predetermined time period and then, the eyes are opened, the CPU 107 displays a predetermined graphical user interface (GUI) via which the user is able to perform an instruction operation.

An HMD for displaying augmented reality displays texts and graphics, such as diagrams and videos, while superimposing the graphics on a real scenery. Therefore, as described above, if graphics are displayed in such a manner that the user's viewing field on a real scenery is blocked while the user is moving on foot, a danger such as a collision or fall may be caused. Accordingly, in the case of a GUI displaying a list of icons respectively indicating apparatus functions, such as the main user interface (UI), it is appropriate to display such a GUI when the user is not moving on foot. Nevertheless, even when the user is not moving on foot, while the user is continuously viewing video contents or the like by using the HMD 100, it is not appropriate to interrupt display of the video contents by displaying a GUI. For this reason, when the user has closed the eyes for at least a predetermined time period T (for example, for one minute) and then opens the eyes, the user is considered to be neither moving on foot nor continuously viewing video contents. Therefore, by displaying a GUI such as the main UI at such a timing, a GUI can be appropriately displayed.

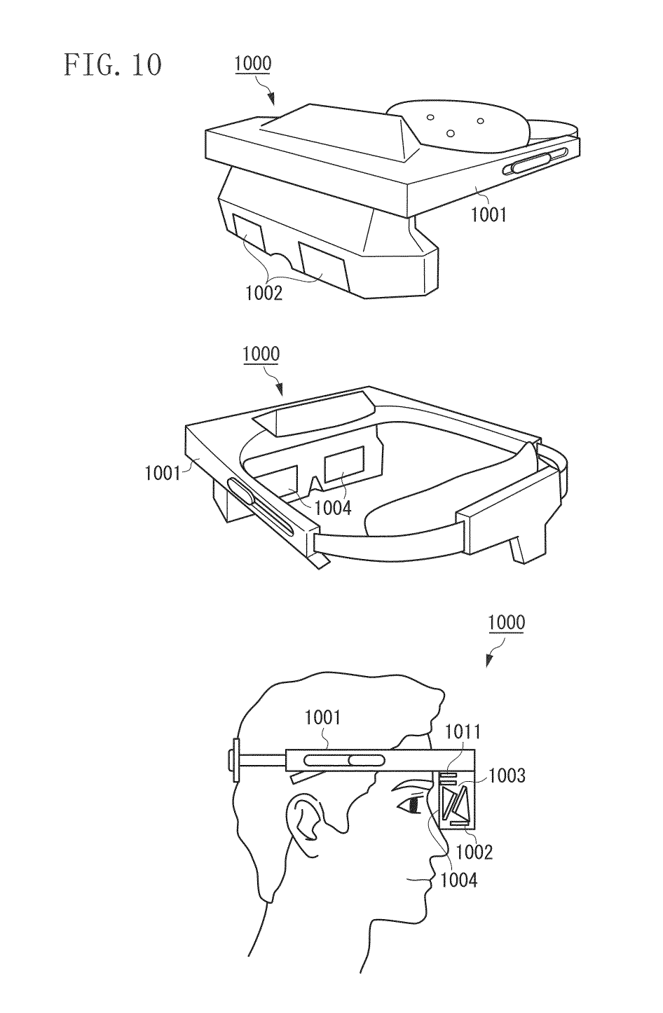

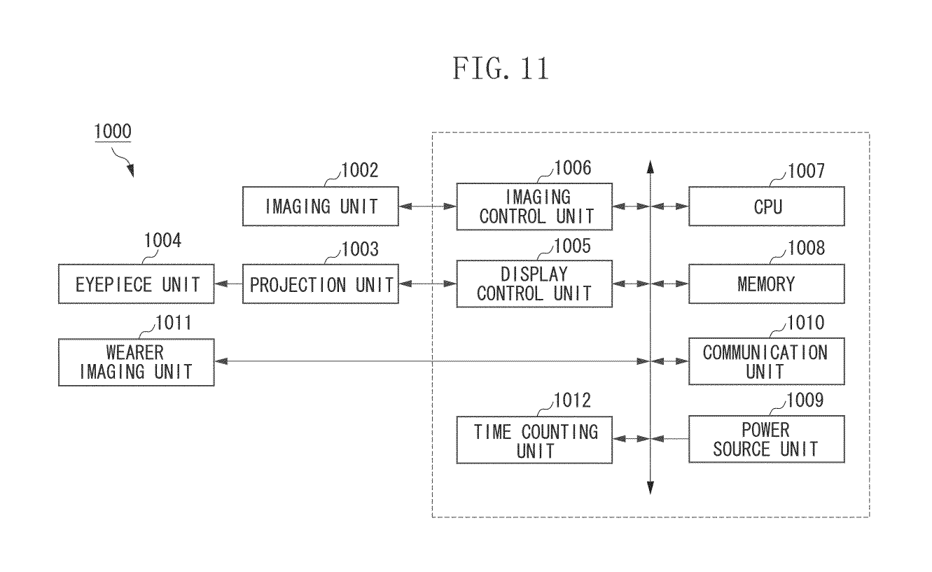

FIG. 10 illustrates an outer appearance of an HMD 1000 according to the present exemplary embodiment.

The HMD 1000 includes a head mounting unit 1001, an imaging unit 1002, a projection unit 1003, and an eyepiece unit 1004.

As illustrated in FIG. 11, the HMD 1000 includes a display control unit 1005, an imaging control unit 1006, a CPU 1007, a memory 1008, a power source unit 1009, and a communication unit 1010. The head mounting unit 1001 through the communication unit 1010 are configured in a similar way to the head mounting unit 101 through the communication unit 110 illustrated in FIGS. 1 and 2.

The HMD 1000 further includes the wearer imaging unit 1011 for imaging a portion including at least the user's eyes. Referring to FIG. 10, the wearer imaging unit 1011 is provided in the vicinity of the projection unit 1003 so that their light paths are substantially conjugated. More specifically, the projection unit 1003 projects graphics by reflecting the image in the direction of the user's eyes by using a mirror provided in the eyepiece unit 1004. The wearer imaging unit 1011 having a light path substantially conjugated with the light path of the projection unit 1003 is able to capture an image of a portion including the user's eyes that is reflected by the mirror in the eyepiece unit 1004. Interference caused by the substantially conjugated light paths can be resolved by, for example, providing on respective light paths polarizing filters for making polarization components perpendicular to one another. The HMD 1000 further includes a time counting unit 1012 for performing time counting by using a timer.

To determine whether the user's (wearer's) eyes are closed or open (eye-closing detection), the HMD 1000 analyzes image data (wearer image data) of the image of the portion including the wearer's eyes that is captured by the wearer imaging unit 1011. More specifically, the HMD 1000 performs, for example, chromatic component analysis. When the eyes are closed, the black component equivalent to the black portions of the eyes and the white component equivalent to the white portions of the eyes decrease compared with those of when the eyes are open. Therefore, it is possible to determine whether the eyes are closed or open based on predetermined threshold values for the black and white components. Alternatively, by performing pattern matching between an image precaptured when the eyes are closed and an image precaptured when the eyes are open, and the wearer image data being captured in real time, it can be determined which of the two precaptured images is more similar to the wearer image data, thereby determining the state of the eyes. Alternatively, by analyzing the amount of change between the wearer image data continuously captured over a predetermined time period, it can be determined that the eyes are closed if the amount of change is small or that the eyes are open if the amount of change is large. This is because the amount of change of the wearer image data when the eyes are open is generally larger than the amount of change when the eyes are closed due to of blink or the like.

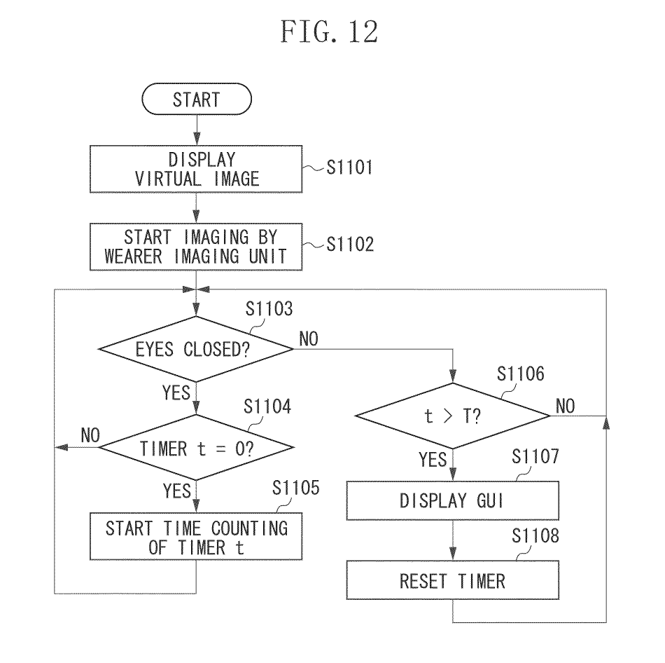

FIG. 12 is a flowchart illustrating determination and processing performed by the HMD 1000 according to the present exemplary embodiment in a case where the above-described display control is performed.

When the user turns power ON, in step S1101, the HMD 1000 according to the present exemplary embodiment displays a virtual image in a predetermined display mode (display position, display area, and transmittance).

In step S1102, the wearer imaging unit 1011 starts imaging. In step S1103, the CPU 107 analyzes the relevant imaging data to determine whether the user's eyes are closed or open. When the CPU 107 determines that the user's eyes are closed (YES in step S1103), then in step S1104, the time counting unit 1012 determines whether a timer t is 0. When the time counting unit 1012 determines that the timer t is 0 (YES in step S1104), then in step S1105, the time count 1012 starts time counting of the timer t.

On the other hand, when the CPU 107 determines that the user's eyes are open (NO in step S1103), then in step S1106, the CPU 107 compares the timer t with the above-described predetermined time period T. When the timer t is larger than the predetermined time period T (YES in step S1106), then in step S1107, the CPU 107 displays a GUI. In step S1108, the CPU 107 resets the timer t.

With the HMD 1000 according to the present exemplary embodiment, by displaying a GUI when the user's eyes are determined to have been closed for a predetermined time period and the eyes are then opened, a GUI can be displayed according to the open/close state of the user's eyes.

Although, in the above-described exemplary embodiments, the present invention is applied to an HMD, the present invention is also applicable to other eyepiece-type display apparatuses, such as a hand-held display which is held by the user's hands so that the display faces the user's eye position.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-076403 filed Apr. 2, 2014, which is hereby incorporated by reference herein in its entirety.

What is claimed is:

1. An eyepiece-type display apparatus comprising:
an imaging unit configured to capture a video of reality;
a display unit configured to display a virtual image while superimposing the virtual image on the video of reality;
a determination unit configured to determine whether a video being captured by the imaging unit is a video during advancing; and
a display control unit configured to, in a case where the determination unit determines that the video being captured by the imaging unit is a video during advancing, change a display mode of the virtual image so as not to block a user's viewing field.

2. The eyepiece-type display apparatus according to claim 1, wherein the display control unit changes a display position of the virtual image.

3. The eyepiece-type display apparatus according to claim 2, wherein the display control unit changes the display position of the virtual image to a peripheral position in a display region of the display unit.

4. The eyepiece-type display apparatus according to claim 1, wherein the display control unit reduces a display area of the virtual image.

5. The eyepiece-type display apparatus according to claim 4, wherein the display control unit reduces the virtual image at a ratio according to a display position of the virtual image.

6. The eyepiece-type display apparatus according to claim 1, wherein the display control unit increases a transmittance of the virtual image.

7. The eyepiece-type display apparatus according to claim 6, wherein the display control unit increases the transmittance of the virtual image at a ratio according to a display position of the virtual image.

8. The eyepiece-type display apparatus according to claim 1, wherein the determination unit determines, based on a result of comparison of a plurality of images captured at a predetermined time interval in a video being captured by the imaging unit, whether a video being captured by the imaging unit is a video during advancing.

9. The eyepiece-type display apparatus according to claim 8, wherein, among the plurality of images captured at the predetermined time interval, the determination unit sets a plurality of regions in a first image, and extracts regions in a second image respectively corresponding to the plurality of regions in the first image, and
wherein, in a case where a distance between the regions in the second image corresponding to the plurality of regions in the first image is longer than a distance between the plurality of regions in the first image, the determination unit determines that the video being captured by the imaging unit is a video during advancing.

10. The eyepiece-type display apparatus according to claim 1, wherein, even in a case where the video being captured by the imaging unit is determined to be a video during advancing, when the virtual image includes an image of advancing navigation information, the display control unit does not change a display mode of the virtual image.

11. The eyepiece-type display apparatus according to claim 10, wherein the imaging unit is capable of capturing a visible light video and an infrared light video,
wherein the imaging unit further includes a measurement unit configured to measure a light amount of a visible light video being captured by the imaging unit, and
wherein, when the light amount of the visible light video is less than a predetermined value, the display control unit causes the display unit to display an image of advancing navigation information superimposed on display of an infrared light video.

12. The eyepiece-type display apparatus according to claim 1, further comprising a movement detection unit configured to detect a movement of the user,
wherein, even if the determination unit determines that the video being captured by the imaging unit is a video during advancing, in a case where the movement detection unit does not detect a movement satisfying a predetermined condition, the display control unit maintains a display mode of a virtual image to be displayed on the display unit without changing the display mode thereof.

13. The eyepiece-type display apparatus according to claim 12, wherein the movement satisfying the predetermined condition is a movement at a predetermined speed or higher.

14. The eyepiece-type display apparatus according to claim 12, wherein the movement satisfying the predetermined condition is a movement with a predetermined moving locus pattern.

15. The eyepiece-type display apparatus according to claim 1, further comprising an eye-closing detection unit configured to detect an open/close state of the user's eyes,
wherein, when the eye-closing detection unit detects that the user's eyes are opened after having been closed for a predetermined time period, the display control unit causes the display unit to display a predetermined graphical user interface via which the user is able to perform an instruction operation.

16. A display control method for controlling display in an eyepiece-type display apparatus having an imaging unit for capturing a video of reality, and a display unit for displaying a virtual image while superimposing the virtual image on the video of reality, the method comprising:
determining whether a video being captured by the imaging unit is a video during advancing, and
changing, in a case where the video being captured by the imaging unit is determined to be a video during advancing, a display mode of a virtual image to be displayed on the display unit so as not to block a user's viewing field.

17. A non-transitory computer-readable storage medium storing a computer program for causing a computer to execute the display control method according to claim 16.
